(19) United States
(12) Patent Application Publication
(10) Pub. No.: US 2018/0365691 A1
(43) Pub. Date: Dec. 20, 2018

(54) IDENTITY LEDGER IN CRYPTO CURRENCY TRANSACTIONS

(71) Applicant: KoopaCoin LLC, Sierra Madre, CA (US)

(72) Inventors: Scott Eugene Sanders, Rocklin, CA (US); David Barbarino Chang, Sierra Madre, CA (US)

(21) Appl. No.: 15/623,632

(22) Filed: Jun. 15, 2017

(51) Int. Cl. G06Q 20/40; G06Q 20/06

(52) U.S. Cl. CPC G06Q 20/401; G06Q 20/065

(57) ABSTRACT

The technology presented here reduces the computational cost in processor cycles, memory, disk space and/or bandwidth by not requiring mining to obtain the system crypto currency. Further, the technology presented here uses a distributed identity ledger to verify transactions, thus avoiding the need to verify an 80 GB block chain. In addition, the entries on the identity ledger can expire after a certain period of time, thus automatically reducing the size of the identity ledger.

### TECHNICAL FIELD

The present application is related to a crypto currency, and more specifically to methods and systems that include an identity ledger in crypto currency transactions.

### BACKGROUND

A cryptocurrency (or crypto currency) is a digital asset designed to work as a medium of exchange using cryptography to secure the transactions and to control the creation of additional units of the currency. Cryptocurrencies are a subset of alternative currencies, or specifically of digital currencies.

Bitcoin became the first decentralized cryptocurrency in 2009. Since then, numerous cryptocurrencies have been created. These are frequently called alt-coins, as a blend of bitcoin alternative. Bitcoin and bitcoin derivatives use decentralized control as opposed to centralized electronic money/centralized banking systems. The decentralized control is related to the use of bitcoin's blockchain transaction database and the role of a distributed ledger.

Today's crypto currencies use computationally intensive methods to mine the currency such as proof of work schemes. A key feature of proof of work scheme is asymmetry: the work must be computationally moderately hard (but feasible) on the requester side but easy to computationally check for the service provider. In other words, the key feature of proof of work is computational cost in processor cycles, memory, disk space and/or bandwidth.

Further, methods to verify transactions using the block chain, such as proof of steak, are computationally intensive. Full clients verify transactions directly on a local copy of the blockchain (over 80 GB as of November 2016, and increasing). Because of its size/complexity, the entire blockchain is not suitable for all computing devices.

### SUMMARY

The technology presented here reduces the computational cost in processor cycles, memory, disk space and/or bandwidth by not requiring mining to obtain the system crypto currency. Further, the technology presented here uses a distributed identity ledger to verify transactions, thus avoiding the need to verify a block chain over 80 GB. In addition, the entries on the identity ledger can expire after a certain period of time, thus automatically reducing the size of the identity ledger. The use of the distributed identity ledger in the current application is approximately 1000 times more energy efficient than proof of work, and approximately 100 times more energy efficient than methods to verify transactions using the block chain.

All transactions within the system presented here are performed by verifiable identities, no anonymous transactions are allowed. By including identity into every transaction, each transaction can be easily verified for know your customer/anti-money laundering (KYC/AML) as well as financial concerns, such as whether the user has the money. The process is much like checking accounts in the real world today, where a check contains someone's identity and an amount to give someone else, and that amount can be captured by the other party by proving their identity. Validation of financial transactions is available to the public, while identity transaction validation and all types of transaction creation are limited to a set of private, invite-only nodes. This federated model will allow for transaction growth and scalability while keeping costs to a minimum.

### BRIEF DESCRIPTION OF THE DRAWINGS

These and other objects, features and characteristics of the present embodiments will become more apparent to those skilled in the art from a study of the following detailed description in conjunction with the appended claims and drawings, all of which form a part of this specification. While the accompanying drawings include illustrations of various embodiments, the drawings are not intended to limit the claimed subject matter.

FIG. 1 shows an architecture of a crypto currency system including identity verification nodes.

FIG. 2 shows a transaction between user A device and user B device using the crypto currency along with an identity ledger.

FIG. 3 shows steps in a process of making a payment with a crypto currency using the identity ledger.

FIG. 4 shows various identity transactions recorded on an identity ledger.

FIG. 5 shows identity ledger entries recorded on an identity ledger.

FIG. 6 shows reliability weight calculation.

FIG. 7 shows contents of a wallet.

FIG. 8 shows a payment transaction performed within the system between user A and user B.

FIG. 9 is a flowchart of a method to reduce computational cost of verifying a crypto currency transaction.

FIG. 10 is a flowchart of a method to efficiently verify an identity of an entity.

FIG. 11 is a diagrammatic representation of a machine in the example form of a computer system within which a set of instructions, for causing the machine to perform any one or more of the methodologies or modules discussed herein, may be executed.

### DETAILED DESCRIPTION

### Terminology

Brief definitions of terms, abbreviations, and phrases used throughout this application are given below.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described that may be exhibited by some embodiments and not by others. Similarly, various requirements are described that may be requirements for some embodiments but not others.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements. The coupling or connection between the elements can be physical, logical, or a combination thereof. For example, two devices may be coupled directly, or via one or more intermediary channels or devices. As another example, devices may be coupled in such a way that information can be passed there between, while not sharing any physical connection with one another. Additionally, the words “herein,” “above,” “below,” and words of similar import, when used in this application, shall refer to this application as a whole and not to any particular portions of this application. Where the context permits, words in the Detailed Description using the singular or plural number may also include the plural or singular number respectively. The word “or,” in reference to a list of two or more items, covers all of the following interpretations of the word: any of the items in the list, all of the items in the list, and any combination of the items in the list.

If the specification states a component or feature “may,” “can,” “could,” or “might” be included or have a characteristic, that particular component or feature is not required to be included or have the characteristic.

The term “module” refers broadly to software, hardware, or firmware components (or any combination thereof). Modules are typically functional components that can generate useful data or another output using specified input(s). A module may or may not be self-contained. An application program (also called an “application”) may include one or more modules, or a module may include one or more application programs.

The terminology used in the Detailed Description is intended to be interpreted in its broadest reasonable manner, even though it is being used in conjunction with certain examples. The terms used in this specification generally have their ordinary meanings in the art, within the context of the disclosure, and in the specific context where each term is used. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that the same element can be described in more than one way.

Consequently, alternative language and synonyms may be used for any one or more of the terms discussed herein, but special significance is not to be placed upon whether or not a term is elaborated or discussed herein. A recital of one or more synonyms does not exclude the use of other synonyms. The use of examples anywhere in this specification, including examples of any terms discussed herein, is illustrative only and is not intended to further limit the scope and meaning of the disclosure or of any exemplified term. Likewise, the disclosure is not limited to various embodiments given in this specification.

### Identity Ledger

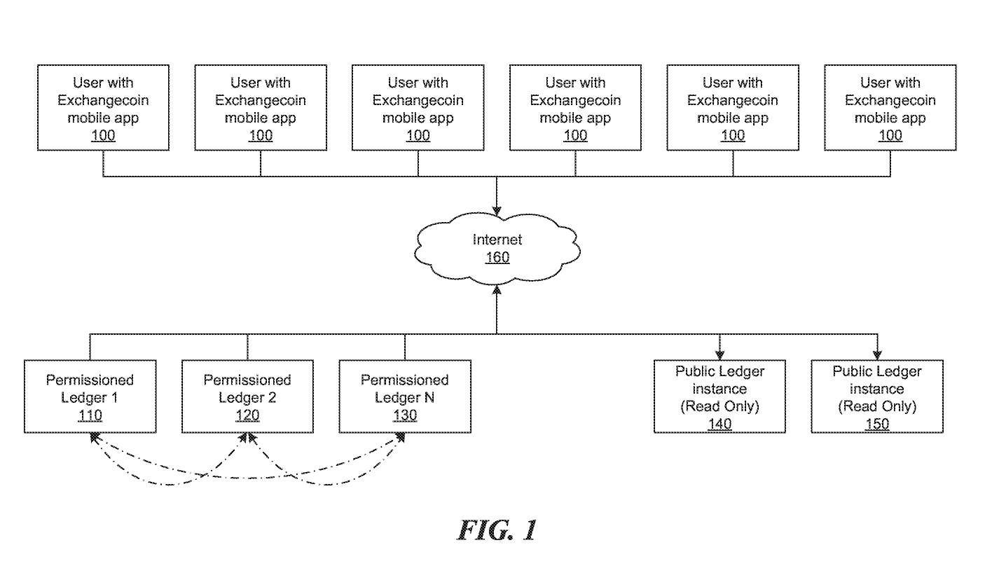

FIG. 1 shows an architecture of a crypto currency system including identity verification nodes. The system includes one or more devices 100 associated with one or more users, one or more private nodes 110, 120, 130, and one or more public nodes 140, 150. The system disclosed in this application does not require mining of coins, however mining can be performed. The device 100, the private nodes 110, 120, 130, and the public nodes 140, 150 communicate with each other via a communication network 160, such as the Internet, cellular network, data network, a mesh network, local area network, etc.

The device 100 can be a personal computer, a mobile device such as a cell phone, a personal digital assistant, etc. The device 100 includes a wallet which can be implemented in software and/or in hardware. A user (the owner of the wallet/identity) associated with the device 100 downloads and opens the application—i.e. wallet. As the user signs up to create an account, a cryptographic pair of keys is created: one public key, and one private key. The private key is stored on the device 100, and is known only to the wallet. From that private key, a wallet address is created. The wallet address and account information is signed with the private key and transmitted to the identity ledger, where the identity ledger adds an identity creation entry containing the wallet address signed with the private key, thus creating an account on the identity ledger. The wallet address can then be used to authorize transactions on the system. A wallet can contain multiple identities, meaning a wallet can be associated with multiple cryptographic pairs of keys. One cryptographic pair of keys is designated as primary and is associated with a wallet on the identity ledger.

The private nodes 110, 120, 130 contain an identity ledger which records identity transactions between two or more devices 100 in the system. The identity ledgers contained in the private nodes 110, 120, 130 are not publicly accessible, and can be accessed only by authorized nodes within the system. The private nodes 110, 120, 130 communicate among each other to create distributed consensus among all private nodes 110, 120, 130 and as a result maintain a synchronized identity ledger. A member of the public cannot view transactions on the identity ledger.

The public nodes 140, 150 contain a financial ledger which records transfer of crypto currency between two or more devices 100 in the system. The financial ledgers can be read by the public, however a member of the public cannot create transactions on the financial ledger.

Both the financial ledger and the identity ledger are permissioned, meaning that, a device wanting to become a ledger node can do so by invitation only. Both of the financial ledger and the identity ledger are distributed across multiple nodes, which communicate among each other to synchronize the financial ledger and the identity ledger.

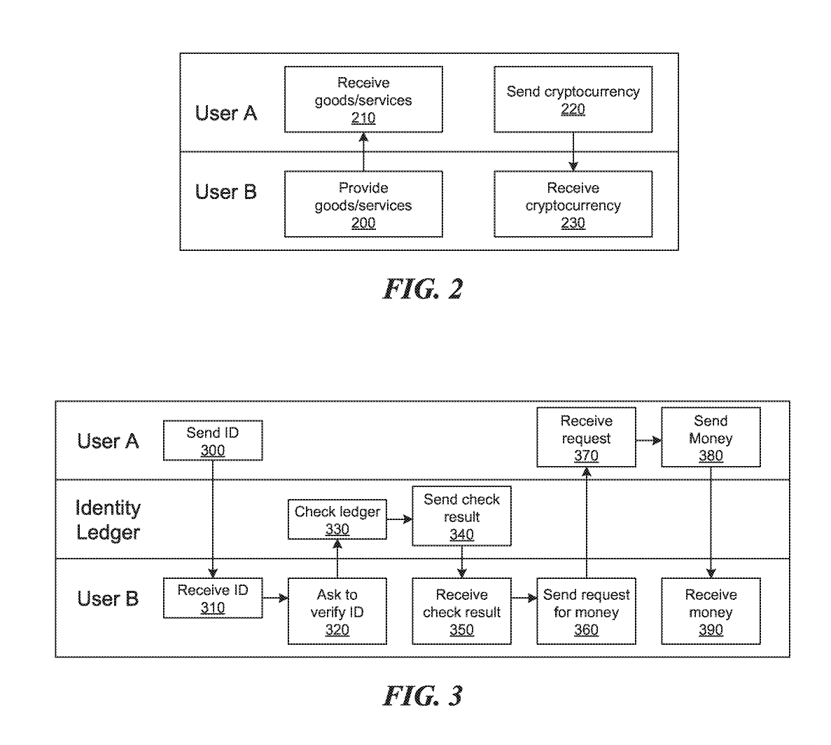

FIG. 2 shows a transaction between user A device and user B device using the crypto currency along with an identity ledger. User B in block 200 provides goods and/or services to user A. User A and/or user A device at block 210 receives goods and/or services. User A device at block 220 sends a payment to user B device in the form of a crypto currency, while user B device at block 230 receives the crypto currency.

FIG. 3 shows steps in a process of making a payment with a crypto currency using the identity ledger. To transact in a crypto currency which does not have an identity ledger, such as bitcoin, a node has to calculate the spendable balance of the payor's bitcoin wallet. To calculate the spendable balance, the node needs to be aware of all previous transactions recorded in a block chain (i.e. big coins distributed financial ledger). This step is resource intensive and requires a lot of CPU cycles, sufficient bandwidth and storage to accommodate the full size of the block chain, which exceeds 80 GB. In the current system, verification of the identity ledger replaces the expensive step of verifying the block chain. The use of the identity ledger in the current application is approximately 100 times more energy efficient than verifying the block chain.

In step 300 user B device sends an identification (i.e. personally identifiable information) associated with user B to user A device. The identification can include user B's public key, user B's wallet address, name, home address, date of birth driver's license, social security number, credit score, a risk-based score determined by programmatic data available to the system, and/or mother's maiden name, etc. If user B is an institution, the identification can include name, address, a risk-based score determined by programmatic data available to the system, type of entity, proof of existence such as certificate of good standing, legal authority for the person acting on behalf of the entity, internal revenue service tax identification number, etc. At step 310 user A device receives the identification associated with user B. At step 320 user A device sends a request to verify the identification associated with user B to one or more identity ledger nodes.

Upon receiving the request to verify the active application, the identity ledger node at step 330 checks the transactions recorded on the identity ledger to verify user B's identity. Checking the identity ledger involves retrieving all the prior unexpired transactions associated with user B's public key, and calculating a reliability weight that the identification is correct. The fact that transactions on the identity ledger can expire, reduces the amount of transactions that the identity ledger node has to check, thus speeding up the verification process, as opposed to the computational intensive block chain verification process. The reliability weight is calculated based on a number of positive verifications, negative claim verifications, and reliability of third parties that have verified user B's identity. A positive verification is when a third party verifies that user B′ identity is valid, while negative verification is when a third party verifies that user B's identity is invalid. At step 340, the identity ledger node returns a probabilistic confirmation that identity associated with user B is valid.

At step 350, user A device receives the probabilistic confirmation. When the probabilistic confirmation is above a certain threshold, such as 0.5 on a scale of 0 to 1, user A device at step 360 sends a request for transfer of funds to user B device.

At step 360 user B device receives the request, and at step 370 user B device sends the funds to user A device. At step 360, user A device receives the sent funds.

In another embodiment, user B device can initially transfer half of the requested funds prior to sending an identification associated with user B to user A device. Upon receipt of the half of the requested funds by user A device, user B sends the identity, as shown in step 300. The rest of the identity verification transaction proceeds as shown in FIG. 3, until step 360, where user A device sends a request for half of the remaining funds. In step 370 user B device receives the request, and at step 380 user B device sends half of the remaining funds to user A device. At step 390 user A device receives the remaining half of the requested funds, thus completing the transaction.

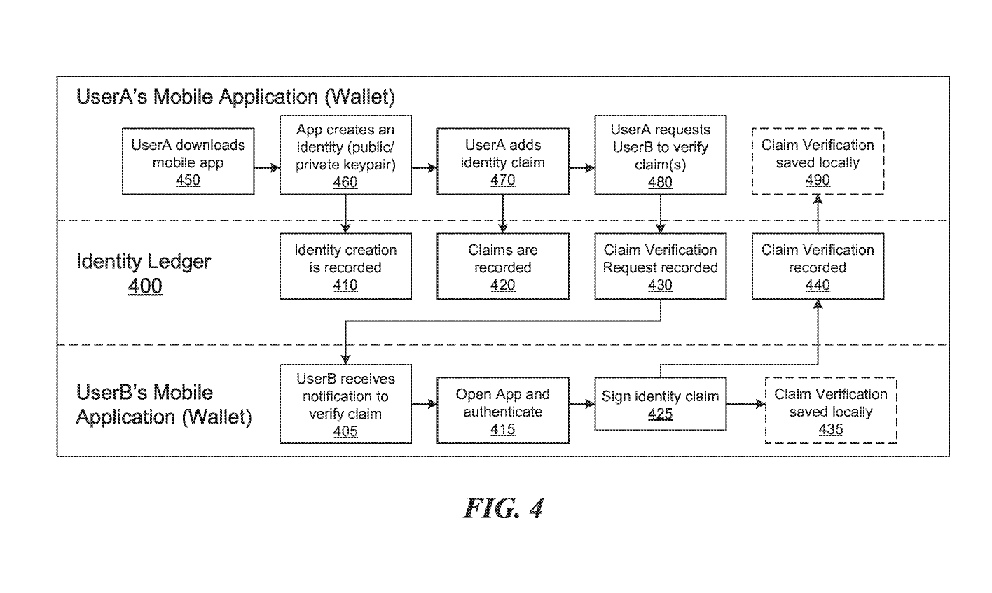

FIG. 4 shows various identity transactions recorded on an identity ledger. The identity ledger 400 includes identity transactions such as identity creation entry recorded in step 410, identity claim entry recorded in step 420, identity verification request entry recorded in step 430, and identity verification entry recorded in step 440. In step 450, user A device downloads an application which enables the user A device to act as a wallet. In step 460 the wallet creates a pair of cryptographic keys including a public key and a private key. The wallet creates a wallet address using the private key. At step 410 one or more identity ledger nodes record that an identity has been created. The identity creation recorded in the identity ledger 400 includes the user A public key and the wallet address.

At step 470 user A device adds identity claims and sends them to the identity ledger node, where the identity ledger node records the identity claim in step 420. An identity claim is sent to the identity ledger node by the identity owner, user A. A third party, such as user B device, can send identity claim suggestions to user A device for the user A to sign, i.e. encrypt with user A's private key. Claim suggestions can be pre-signed with a private key of the third party. An identity claim can expire after a certain period of time, such as 6 months. The identity claim can be revoked by user A device. The identity claim can be public or private. In other words, the identity claim can be shared only when necessary. An identity claim can be verified on the identity ledger 400 by other entities.

Verification of a user's identity can be performed in various ways. For example, user A is an individual using an online and/or offline merchant, user B. A successful transactions between user A and the merchant, user B, validates the merchant's identity. In another example, the merchant, user B, validates user A's name and address for an order of goods to complete successfully.

In step 480 user A can request user B to verify user A's identity claims. Identity ledger node in step 430 records claim verification request sent by user A. In step 405, user B device receives notification to verify the identity claim sent by user A device. In step 415, user B opens up the wallet on user B device and authenticates user A's identity claim. For example, an identity claim can contain user A driver's license. To verify the identity claim, user B can verify that user A driver's license corresponds to user A and is valid. Upon verifying that user A driver's license corresponds to user A and is valid, user B device in step 425 encrypts user A identity claim with user B's private key and sends the encrypted identity claim to the identity ledger node. In step 440, the identity ledger node records the encrypted identity verification on the identity ledger 400.

In an optional step 490, the identity verification by user B can be saved locally on user A device. Next time, a third party, such as a user C device, requests identity verification of user A, user A device can supply all the unexpired identity verifications associated with user A stored on user A device. Directly receiving unexpired identity verifications associated with user A at user B device saves computational resources such as processor cycles and memory by avoiding verification of the full block chain as is done by bitcoin. Further, instead of traversing the full identity ledger 400 searching for identity verifications associated with user A, user B device directly receives all the relevant identity verifications associated with user A from user A device.

In addition, in an optional step 435, user B device can record the identity verifications that user B preformed. Next time user B interacts with user A, user B can verify user A identity by retrieving identity verifications of user A that were performed by user B. Such an identity verification also reduces the consumption of computational resources such as processor cycles and memory by verifying only a small number of relevant identity verifications.

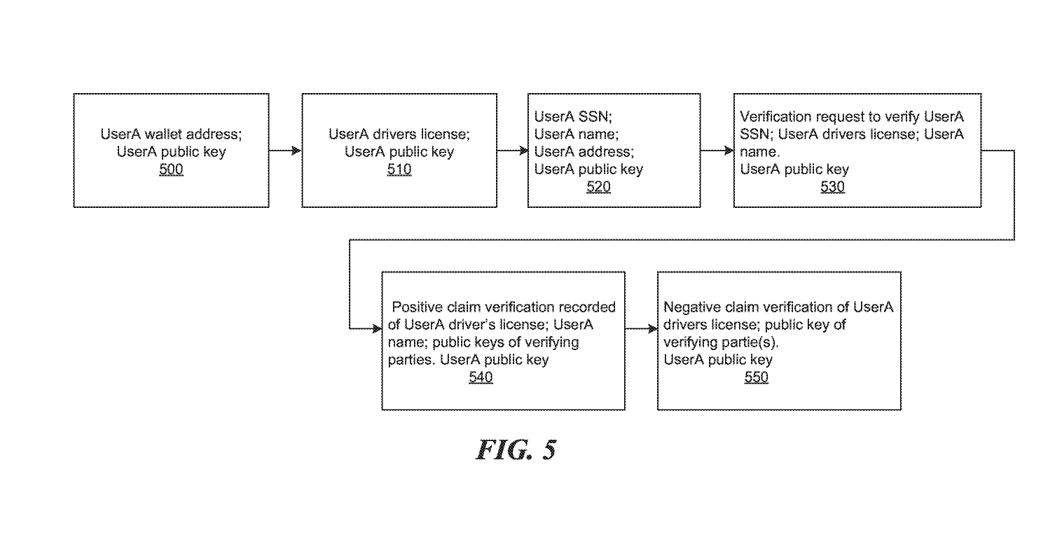

FIG. 5 shows identity ledger entries recorded on an identity ledger. Identity ledger entry 500 is an identity creation entry including a wallet address and a public key associated with the wallet address, for example user A public key. Identity ledger entry 510 is an identity claim entry including an identification such as user A driver's license and user A public key. Driver's license can be encrypted with user A private key to show that user A made the identity claim.

Identity ledger entry 520 is an additional identity claim entry including additional identification such as user A Social Security number, user A name, user An address, and a user A public key. The Social Security number, user A name, user An address can be encrypted with the user A private key to show that user A made the identity claim.

Identity ledger entry 530 is a verification request to verify user A's identification. User A's identification can be part of one or more identity claims made by user A. For example the verification request can include a request to verify user A Social Security number and user A name from identity ledger entry 520, and user A driver's license from identity ledger entry 510. User A Social Security number, user A name, and user A driver's license can be encrypted with the user A private key to show that user A made the verification request. Identity ledger entry 530 can include user A public key.

Identity ledger entry 540 is a bundled claim verification of user A's driver's license, and user A's name. A bundled claim verification contains more than one claim identification. A bundled claim verification can contain verifications associated with one or more users. A positive verification 540 means that one or more verifying parties assert and the truthfulness of user A's driver's license and user A's name. The identity verification 540 is encrypted with the private keys of one or more verifying parties. Further, the claim verification includes user A public key and public keys of the one or more verifying parties.

Identity ledger entry 550 is a claim verification of user A's driver's license. The identity verification entry 550 includes public keys of verifying parties, user A public key, and user A driver's license which can be encrypted with a private key of verifying parties. The identity verification entry 550 is a negative verification, meaning that the verifying parties assert and that the identity claim is false, or could not or ascertain the truthfulness of the identity claim. A bundled claim verification, such as identity verification 540, can include both positive verification and negative verification.

In a subsequent crypto currency transaction between two parties, user A and user B, user B may query an identity ledger node containing the identity ledger to verify identity associated with user A. For example, user A device may have provided user A's driver's license to user B device. User B device can ask the identity ledger node to verify user A's driver's license. In that case, the identity ledger node retrieves both the positive claim verification and the negative claim verification of user A driver's license from the identity ledger entry 540 and computes a reliability weight of the various claim verifications. The identity ledger node sends the reliability weight to user B device.

As explained in this specification, all identity ledger entries except the identity creation entry 500 can expire after a predetermined amount of time, such as 6 months. The expiration of identity ledger entries increases the accuracy of identity verification by avoiding using an expired identity verification. Further, the expiration of identity ledger entries increases the speed of the identity verification by reducing the number of identity verifications to search in calculating the reliability weight to send to user B device.

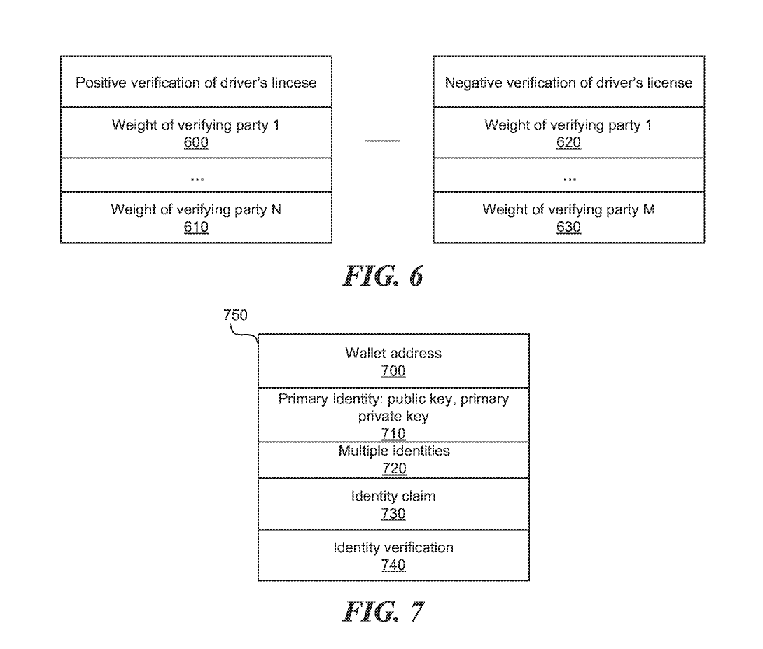

FIG. 6 shows reliability weight calculation. To calculate reliability weight associated with an identity of user A, an identity ledger node retrieves one or more identity verification entries 600, 610, 620, 630 associated with the identity of user A. Each verifying party has a reliability weight which depends on how frequently the verifying party has positively verified a false identification, and has negatively identified a true identification. The more frequently a verifying party has positively verified a false identification and/or has negatively identified a true identification, the less reliable the verifying party is. The reliability weight associated with the identity of user A is computed by increasing the resulting reliability by a reliability weight of a positively verifying third party, and by decreasing the resulting reliability by a reliability weight of a negatively verifying third party.

Assume we have an identity ledger as shown in FIG. 5, and that the identity ledger node needs to calculate a reliability weights of the user A driver's license. The identity ledger node can add the reliability weight of all the parties listed in the positive verification entry 540 and can subtract the reliability weight of all the parties listed in the negative verification entry 550. The obtained result is returned to a device querying the identity of user A. The reliability weight of all the parties can be stored on the identity ledger, or can be computed each time a reliability weight of an identity needs to be computed.

FIG. 7 shows contents of a wallet. A wallet 750 can be implemented in software and/or in hardware on a device such as a mobile device, a personal computer, a cloud, etc. Additionally, a web application can allow a user to temporarily use the user's wallet in the cases of user having their mobile wallet and/or personal computer wallet with them.

The user can sign up on the system to create an account. When the account is created a cryptographic pair of keys 710 is created: one public key, and one private key. The private key is stored within the wallet 750, and is known only to the wallet 750. The public key is also stored within the wallet 750, however, the public key is known to the public. From the private key, a wallet address 700 is created. The wallet address 700 is stored within the wallet 750. The wallet address 700 and account information is encrypted with the private key and transmitted to the identity ledger, where the identity ledger adds an identity creation entry containing the wallet address 700 signed with the private key, thus creating an account on the identity ledger. The wallet address 700 can then be used to authorize transactions on the system.

A wallet 750 can contain multiple identities 720, meaning a wallet can be associated with multiple cryptographic pairs of keys. One cryptographic pair of keys is designated as primary 710 and is associated with a wallet on the identity ledger. The remainder of the cryptographic keys associated with multiple identities 720 are stored within the wallet 750.

The wallet 750 can include one or more identity claims 730. The identity claims 730 can be recorded both in the wallet 750 and on the identity ledger. The identity claims that are required for individuals include name, address, risk-based score determined but automatic data available to the system, date of birth. If you identity claims that are required for an legal entity include name, address, risk-based score determined by programmatic data available to the system, type of entity, proof of existence, Internal Revenue Service tax identification number, and legal authority a person acting on behalf of the entity.

Both US domestic addresses and international addresses may be used. However in cases where international registrations occur, an enhanced level of validation and checks is required. At minimum the system: validates against office of foreign assets control (OFAC) list, assigns a higher risk-based score, and monitors such accounts with a higher level of scrutiny. Additionally, Politically Exposed Persons will be subject to increased scrutiny and monitoring. Monitoring activity by the system can result in the submission of Suspicious Activity Reports to the relevant authorities.

The wallet 750 can include one or more identity verifications 740. The identity verifications 740 can be recoded both in the wallet 750 and on the identity ledger. The identity verifications 740 include identity claim encrypted with a private key of a third party who verified the identity claim, along with the public key of the wallet owner. In cases where a bank account is contained in the identity claim, the verifying third party is the financial institution responsible for the bank account. When another user of the system asks for wallet owner's identity verification, the wallet 750 can supply the identity verifications 740. Alternatively, another user of the system can verify the identity of the wallet owner by querying the identity ledger.

The wallet 750 can use various forms of authentication to allow user access, including but not limited to password access, facial recognition, fingerprint, or other biometric sources. Initial funding of the wallet and ownership of crypto currency used in the system (i.e. system crypto currency) can take place via a few different methods: 1. purchase of the system crypto currency, 2. receipt of system crypto currency from a third party, or 3. exchange of crypto currency external to the system into the system crypto currency (e.g. exchange a bitcoin or alt-coins into system crypto currency).

First, the purchase of the system crypto currency can be done using a credit card and/or debit card, or can be done using a bank transfer. In case of a credit card, initial identity will be ascertained by verifying bank identification number (BIN) and address information with the issuing bank along with the usage of third party fraud and identity verification services. In cases where a bank transfer is used, linking the bank to the wallet serves as an initial claim verification.

Second, the wallet 750 can be funded by receipt of system crypto currency from a third party. In cases where the wallet 750 is funded directly by the system crypto currency, an independent identity verification and identity claim must be initiated. For example, an identity claim can include linking a bank account or providing personal data that can be verified by a third party such as the bank providing the bank account, or an identity service such as Experian, respectively.

Third, the wallet 750 can be funded by exchange of crypto currency external to the system into the system crypto currency. For example, a bitcoin or alt-coins can be exchanged into the system crypto currency. In cases where the wallet 750 is funded by exchange of crypto currency, an independent identity verification and identity claim must be initiated. For example, an identity claim can include linking a bank account or providing personal data that can be verified by a third party such as the bank providing the bank account, or an identity service such as Experian, respectively.

Buying the system crypto currency via fiat currency (or fiat currency proxy like credit) and/or external crypto currencies, or selling the system crypto currency for the same, poses particular use cases because the exchanges used may not be identified to the system before the exchange. The system treats an exchange just like any other entity which requires identification to the system. Transactional and identity information will be recorded for each transaction with an exchange/interchange. To the extent possible, identity claims will be collected from each transaction with an exchange for all parties—the exchange, the selling (or crediting) party, and the buying party.

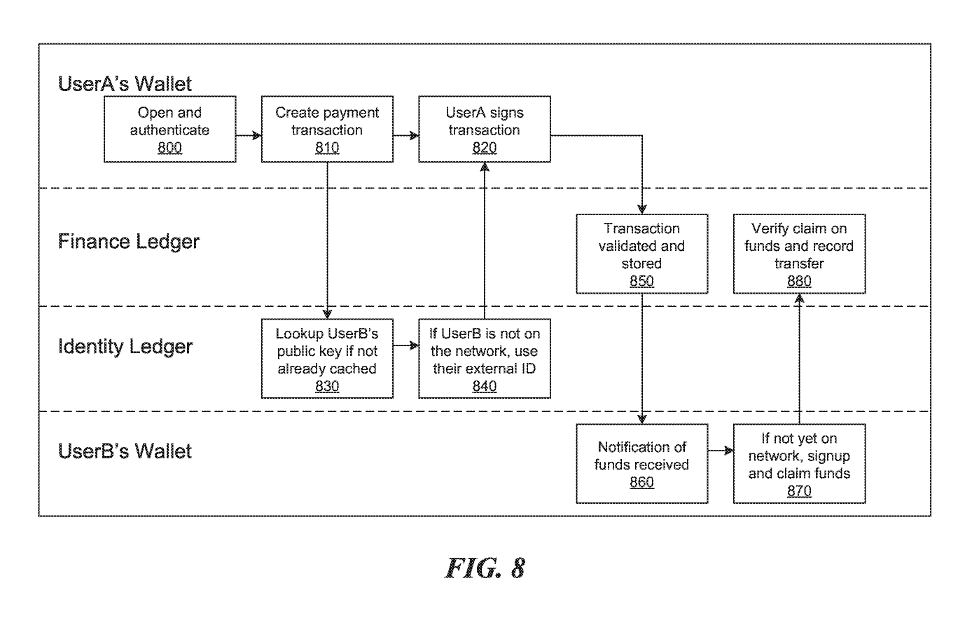

FIG. 8 shows a payment transaction performed within the system between user A and user B. Once a user has enough identity claims and verifications, they are allowed to use the system to deposit, transfer, and convert the system crypto currency. The amount of verifications to be able to financially transact at a minimum meet the user's local requirements for know your customer (KYC). Merchants can also require other identity claims, such as the buyer be over 21 years of age.

In step 800, user A opens a wallet running on a user A device, such as a mobile device, a personal computer, or a cloud, and authenticates himself. In step 810, user A device creates a payment transaction by sending to an identity ledger node a query for user B's public key. In step 830, the identity ledger node containing the identity ledger looks up user B's public key if user B's public key is not already cached. The lookup can be performed using an identity associated with user B, such as user B's name. If user B's public key is cached, the lookup can be performed using a cache lookup. If user B's public key is not cached, the identity ledger node traverses the entries on the identity ledger to retrieve user B's public key.

In step 840, if user B does not have a public key in the system, the identity ledger node returns an empty public key. In that case, user A's wallet uses external ID associated with user B such as user B's email. In step 820, user A device signs the transaction by encrypting the transaction information using user A's private key. In step 850, a finance ledger node validates and stores the transaction on a finance ledger. Validation of the transaction involves the finance ledger node validating that user A has sufficient funds to make the payment.

In step 860, user B device receives notification of funds received. In step 870, if user B is not on the network, user B signs up on the network and claims funds. In step 880, the finance ledger node verifies claim of funds and records the transfer.

Finance entries on the finance ledger: 1. Have a transaction identification (ID) and version 2. Have a date time stamp, 3. Include the sender's public key, 4. Include the receiver's public key or external ID such as email address, 5. Have a transaction type, 6. Have a currency amount, 7. Are signed by the sender's private key.

External IDs in element 4 are temporary accounts while the new user registers on the system and eventually claims the funds. The transaction type in element 5 can be: a. Currency transfer, b. Fiat currency exchange, c. Currency creation, d. Currency transfer request, e. Currency transfer authorization request (like a credit card authorization).

The transaction, once signed by the sender, is sent to one or more finance ledger nodes to be integrated into the finance ledger. Transactions are valid if: 1. The sender has a balance greater than the amount being sent, and 2. The transaction signature can be verified with the sender's public key. Once confirmed, the transaction is stored in the next finance ledger block, the balance of the receiver is updated and their wallet is notified.

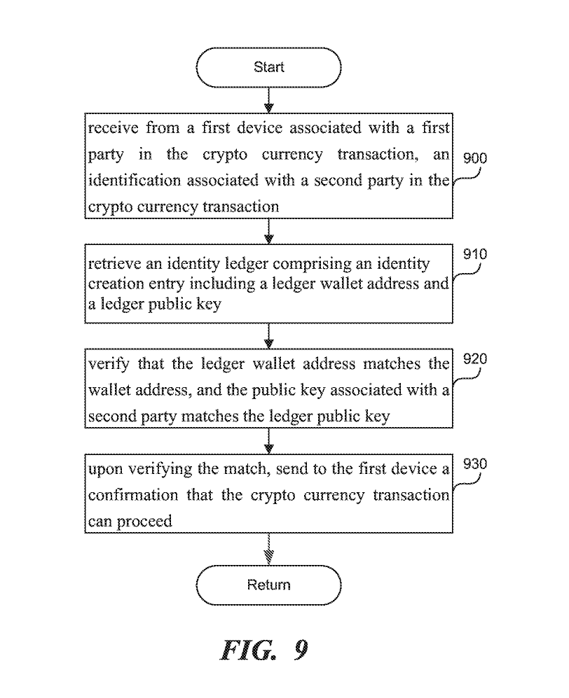

FIG. 9 is a flowchart of a method to reduce computational cost of verifying a crypto currency transaction. In step 900, an identity ledger node receives from a first device associated with a first party (e.g. user A) in the crypto currency transaction, an identification associated with a second party (e.g. user B) in the crypto currency transaction. The identification includes a public key of the second party and a wallet address associated with the private key of the second party. As described in this application, from the primary private key, a wallet address is created. As described in this application, one wallet can contain multiple identities.

In step 910, the identity ledger node retrieves an identity ledger including an identity creation entry. The identity creation entry includes a ledger wallet address and a ledger public key. As described in this application, the identity ledger can include identity creation entry, identity claim entry, identity verification request, identity verification entry.

In step 920, the identity ledger node verifies that the ledger wallet address matches the wallet address, and the public key of a second party matches the ledger public key. In step 930, upon verifying the match, the identity ledger node sends to the first device a confirmation that the crypto currency transaction can proceed. The confirmation that the crypto currency transaction can proceed uses less computational resources such as CPU cycles and memory because the confirmation, unlike in bitcoin ledgers, is performed without verifying the whole block chain.

In one embodiment, the identification associated with the second party received in step 900, includes a personally identifiable information, such as driver's license, Social Security number, credit score, name, address, mother's maiden name, etc. The identity ledger includes an identity verification entry including a ledger personally identifiable information, which can be encrypted with the private key of the second party, and verified with a private key of a third party. In this embodiment, in step 920, the identity ledger node verifies the identity of the second party by: decrypting the ledger personally identifiable information with the public key of the third party and/or the public key of the second party; verifying that the ledger personally identifiable information matches the personally identifiable information of the second party; and upon verifying the match, sending to the first device a confirmation that the crypto currency transaction can proceed.

In another embodiment, the identification associated with the second party received in step 900, includes a personally identifiable information, such as driver's license, Social Security number, credit score, name, address, mother's maiden name, etc. The identity ledger includes an identity verification entry including a ledger personally identifiable information, which can be encrypted with the private key of the second party, and verified with a private key of a third party. In this embodiment, in step 920, the identity ledger node verifies the identity of the second party by: decrypting the ledger personally identifiable information with the public key of the third party and/or the public key of the second party; verifying that the ledger personally identifiable information matches the personally identifiable information of the second party; computing a reliability weight associated with the public key of the third party; and upon verifying the match, sending to the first device the reliability weight as a probabilistic confirmation that the crypto currency transaction can proceed.

The identity ledger includes multiple identity verification entries signed by multiple private keys associated with verifying third parties. Each identity verification entry in multiple identity verification entries includes a positive verification and a negative verification, as described in this application. To compute the reliability weight, the identity ledger node retrieves multiple reliability weights associated with multiple third parties. The identity ledger node computes a resulting reliability by increasing the resulting reliability by a reliability weight of a positively verifying third party, and decreasing the resulting reliability by a reliability weight of a negatively verifying third party. Finally, the identity ledger node sends to the first device the resulting reliability as a probabilistic confirmation that the crypto currency transaction can proceed.

The identity ledger node can record in the identity ledger an identity claim including a personally identifiable information associated with the second party, which can be encrypted by the private key of the second party, and a public key of the second party. After a predetermined amount of time, such as 6 months, the identity ledger node can remove the identity claims from the identity ledger.

The identity ledger node can record in the identity ledger an identity verification of the identity claim. The identity verification includes the identity claim and a public key of a third party verifying the identity claim. As described in this application, the identity verification can be a positive verification indicating that the third party has verified that the personally identifiable information is associated with the second party or a negative verification indicating that the third party has verified that the personally identifiable information is not associated with the second party. After a predetermined amount of time, such as 6 months, the identity ledger node can remove the identity claim verification from the identity ledger.

In one embodiment, the crypto currency transaction can be initiated by transferring from a payor's device a first half of the crypto currency to be exchanged in the transaction to the payee's device and recording the transfer in a financial ledger. Upon completing the first half of the transfer, the identity ledger node verifies the identification associated with the second party. The crypto currency transaction is completed by transferring a second half of the crypto currency to be transferred in the transaction to the second party and recording the transfer in the financial ledger.

In one embodiment, the identity ledger node can record in the identity ledger a bundled identity verification containing multiple identity claims, and one or more public keys of one or more third parties verifying the multiple identity claims. An identity verification in the bundled identity verification can be a positive verification indicating that the third party has verified that an identity claim among multiple identity claims is associated with the second party or a negative verification indicating that the third party has verified that the identity claim is not associated with the second party. The identity ledger node can extract one or more identity verifications from the bundled identity verification. The extraction can be done in response to receiving a request to confirm an identity of a party in a transaction.

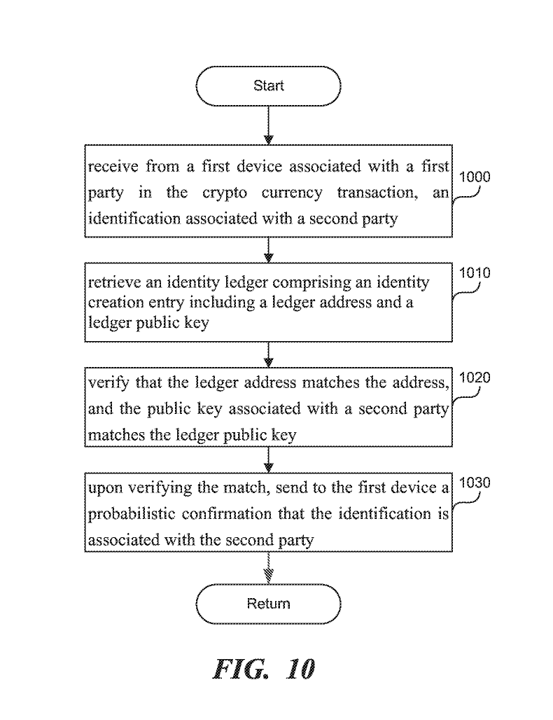

FIG. 10 is a flowchart of a method to efficiently verify an identity of an entity. In step 1000, an identity ledger node receives from a first device associated with a first party (e.g. user A), an identification associated with a second party (e.g. user B). The identification includes a public key of the second party and an address associated with the private key of the second party.

In step 1010, the identity ledger node retrieves an identity ledger comprising an identity creation entry including a ledger address and a ledger public key. The identity ledger is distributed among multiple private nodes in consensus regarding the identity ledger. Consensus between the private nodes can be reached in several ways. For example, each private node publishes a public key of the private node to other nodes among multiple private nodes. Messages coming through the private node are signed by the private node to verify its format. Once enough identical responses are reached, then a consensus is met that the message is a valid transaction. In another example, a private node in question waits for the vast majority of the other private nodes to agree on a transaction, considering the transaction settled. In turn, the important participants mentioned do not agree to the transaction until the participants they consider important agree as well, so on and so forth. Eventually, enough of the network would accept the transaction, such that an attacker cannot rollback the transaction.

In step 1020, the identity ledger node verifies that the ledger address matches the address, and the public key of a second party matches the ledger public key. In step 1030, upon verifying the match, the identity ledger node sends to the first device a probabilistic confirmation that the identification is associated with the second party.

In one embodiment, the identification associated with a second party includes a personally identifiable information, such as driver's license, Social Security number, credit score, name, address, mother's maiden name, etc. The identity ledger includes an identity verification entry including a ledger personally identifiable information, which can be encrypted with the private key of the second party, and verified with a private key of a third party. In this embodiment, in step 1020, the identity ledger node performs the verification by: decrypting the ledger personally identifiable information with the public key of the third party and/or the public key of the second party; verifying that the ledger personally identifiable information matches the personally identifiable information of the second party; and upon verifying the match, sending to the first device the reliability weight as a probabilistic confirmation that the crypto currency transaction can proceed.

In one embodiment, the identity ledger includes multiple identity verification entries verified by multiple private keys associated with one or more third parties. Each identity verification entry among multiple identity verification entries includes a positive verification and a negative verification. The identity ledger node computes the reliability weight by: retrieving multiple reliability weights associated with multiple third parties; computing a resulting reliability by increasing the resulting reliability by a reliability weight of a positively verifying third party, and decreasing the resulting reliability by a reliability weight of a negatively verifying third party; and sending to the first device the resulting reliability as a probabilistic confirmation that the crypto currency transaction can proceed.

The identity ledger node can record in the identity ledger an identity claim including a personally identifiable information associated with the second party encrypted by the private key of the second party, and a public key of the second party. The identity ledger node can remove the identity claim from the identity ledger after a predetermined amount of time.

The identity ledger node can record in the identity ledger an identity verification of the identity claim. The identity verification includes the identity claim and a public key of a third party verifying the identity claim, wherein the identity verification comprises a positive verification indicating that the third party has verified the personally identifiable information is associated with the second party or a negative verification indicating that the third party has verified that the personally identifiable information is not associated with the second party. The identity ledger node can remove the identity claim from the identity ledger after a predetermined amount of time, such as 6 months.

In addition to verifying crypto currency transactions, the system described in the present application can be used to transfer and record title ownership of property. For example, in real estate transactions, the recording entity of record (in the us, the local county recorders office) can build their identity on the identity ledger, and then when they record the title transfer, they can create an identity for the property, with the property's lot number, description, location, etc., and transfer ownership to the purchasing entity via a transaction that assigns ownership to the property to the purchasing entity. In this case, real property can have an identity on the identity ledger, as well as government entities, alongside corporate entities and people. Metadata would be added to allow the property to be owned/transacted.

Similarly, other titled property, like vehicles, can be transacted on the identity ledger. An identity is set up for the vehicle, and then the purchase transaction assigns ownership of that property to the entity making the purchase. An entity such as the Manufacturer can validate the vehicle identification number (VIN) and manufacturer's statement of origin (MSO). Also, the state Department of Motor Vehicles (DMV) can validate registration information on the VIN.

Further, given that the system has verified identity and built up claims on the verified identities, the system can be extended to form a credit score and allow system users to extend credit and/or loan to other users. For example, a loan is created with an identity, the source of verification being the lendee. The lendee can verify the loan by signing the loan with the lendee's private key. Once the lender receives the loan request, the lender can also sign the loan and transfer the money lent via the financial ledger. Payments made by the lendee to the lender can reference the loan identity as well, and the loan balance can be reduced at the agreed upon rate.

### Computer

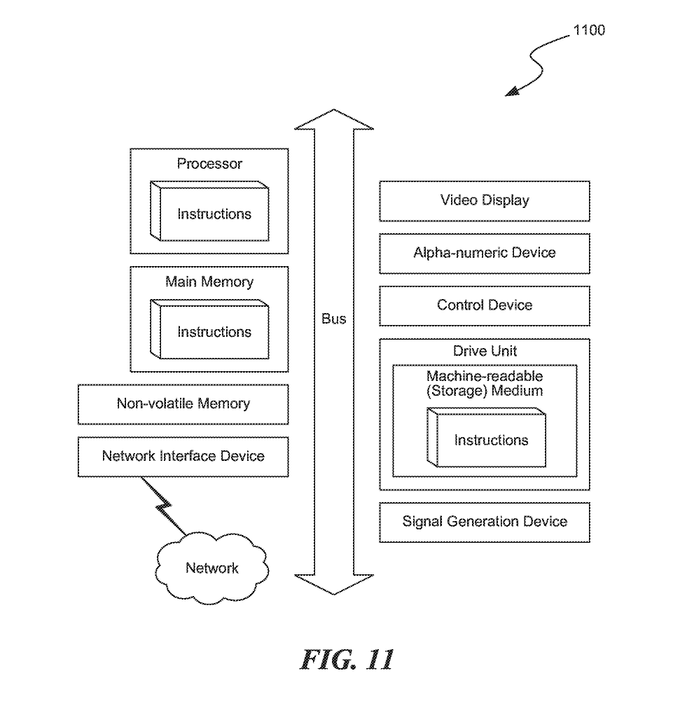

FIG. 11 is a diagrammatic representation of a machine in the example form of a computer system 1100 within which a set of instructions, for causing the machine to perform any one or more of the methodologies or modules discussed herein, may be executed.

The system depicted in FIG. 11 can: enable the operation the wallet of a system user, enable the operation of an identity ledger node, and/or enable the operation of a finance node. The network depicted in FIG. 11 can enable the communication between the wallet of the user, the identity ledger node, and the finance node.

In the example of FIG. 11, the computer system 1100 includes a processor, memory, non-volatile memory, and an interface device. Various common components (e.g., cache memory) are omitted for illustrative simplicity. The computer system 1100 is intended to illustrate a hardware device on which any of the components described in the example of FIGS. 1-10 (and any other components described in this specification) can be implemented. The computer system 1100 can be of any applicable known or convenient type. The components of the computer system 1100 can be coupled together via a bus or through some other known or convenient device.

This disclosure contemplates the computer system 1100 taking any suitable physical form. As example and not by way of limitation, computer system 1100 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, computer system 1100 may include one or more computer systems 1100; be unitary or distributed; span multiple locations; span multiple machines; or reside in a cloud, which may include one or more cloud components in one or more networks. Where appropriate, one or more computer systems 1100 may perform without substantial spatial or temporal limitation one or more steps of one or more methods described or illustrated herein. As an example and not by way of limitation, one or more computer systems 1100 may perform in real time or in batch mode one or more steps of one or more methods described or illustrated herein. One or more computer systems 1100 may perform at different times or at different locations one or more steps of one or more methods described or illustrated herein, where appropriate.

The processor may be, for example, a conventional microprocessor such as an Intel Pentium microprocessor or Motorola power PC microprocessor. One of skill in the relevant art will recognize that the terms “machine-readable (storage) medium” or “computer-readable (storage) medium” include any type of device that is accessible by the processor.

The memory is coupled to the processor by, for example, a bus. The memory can include, by way of example but not limitation, random access memory (RAM), such as dynamic RAM (DRAM) and static RAM (SRAM). The memory can be local, remote, or distributed.

The bus also couples the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer 1100. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

Software is typically stored in the non-volatile memory and/or the drive unit. Indeed, storing and entire large program in memory may not even be possible. Nevertheless, it should be understood that for software to run, if necessary, it is moved to a computer readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

The bus also couples the processor to the network interface device. The interface can include one or more of a modem or network interface. It will be appreciated that a modem or network interface can be considered to be part of the computer system 1100. The interface can include an analog modem, ISDN modem, cable modem, token ring interface, satellite transmission interface (e.g. “direct PC”), or other interfaces for coupling a computer system to other computer systems. The interface can include one or more input and/or output devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device. For simplicity, it is assumed that controllers of any devices not depicted in the example of FIG. 11 reside in the interface.

In operation, the computer system 1100 can be controlled by operating system software that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux™ operating system and its associated file management system. The file management system is typically stored in the non-volatile memory and/or drive unit and causes the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may thus be implemented using a variety of programming languages.

In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies or modules of the presently disclosed technique and innovation.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

### Remarks

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling others skilled in the relevant art to understand the claimed subject matter, the various embodiments, and the various modifications that are suited to the particular uses contemplated.

While embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Although the above Detailed Description describes certain embodiments and the best mode contemplated, no matter how detailed the above appears in text, the embodiments can be practiced in many ways. Details of the systems and methods may vary considerably in their implementation details, while still being encompassed by the specification. As noted above, particular terminology used when describing certain features or aspects of various embodiments should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless those terms are explicitly defined herein. Accordingly, the actual scope of the invention encompasses not only the disclosed embodiments, but also all equivalent ways of practicing or implementing the embodiments under the claims.

The language used in the specification has been principally selected for readability and instructional purposes, and it may not have been selected to delineate or circumscribe the inventive subject matter. It is therefore intended that the scope of the invention be limited not by this Detailed Description, but rather by any claims that issue on an application based hereon. Accordingly, the disclosure of various embodiments is intended to be illustrative, but not limiting, of the scope of the embodiments, which is set forth in the following claims.

1. A method to reduce computational cost of verifying a crypto currency transaction comprising:
receiving from a first device associated with a first party in the crypto currency transaction, an identification associated with a second party in the crypto currency transaction, the identification comprising a public key of the second party and a wallet address associated with a private key of the second party;
retrieving an identity ledger comprising an identity creation entry including a ledger wallet address and a ledger public key, wherein the identity ledger is distributed among a plurality of private nodes in consensus regarding the identity ledger;
verifying that the ledger wallet address matches the wallet address, and the public key of the second party matches the ledger public key; and
upon verifying the match, sending to the first device a confirmation that the crypto currency transaction can proceed.

2. The method of claim 1, wherein the identification associated with the second party comprises a personally identifiable information;
wherein the identity ledger comprises an identity verification entry including a ledger personally identifiable information encrypted with the private key of the second party, and verified with a private key of a third party;
wherein said verifying comprises:
decrypting the ledger personally identifiable information with the public key of the third party in the public key of the second party;
verifying that the ledger personally identifiable information matches the personally identifiable information of the second party; and
upon verifying the match, sending to the first device the confirmation that the crypto currency transaction can proceed.

3. The method of claim 2, said verifying comprising:
decrypting the ledger personally identifiable information with the public key of the third party and the public key of the second party;
verifying that the ledger personally identifiable information matches the personally identifiable information of the second party;
computing a reliability weight associated with the public key of the third party; and
upon verifying the match, sending to the first device the reliability weight as a probabilistic confirmation that the crypto currency transaction can proceed.

4. The method of claim 3, wherein the identity ledger comprises a plurality of identity verification entries verified by a plurality of private keys associated with third parties, wherein each identity verification entry in the plurality of identity verification entries comprises a positive verification and a negative verification;
said computing the reliability weight comprising:
retrieving a plurality of reliability weights associated with the plurality of third parties;
computing a resulting reliability by increasing the resulting reliability by a reliability weight of a positively verifying third party, and decreasing the resulting reliability by a reliability weight of a negatively verifying third party; and
sending to the first device the resulting reliability as the probabilistic confirmation that the crypto currency transaction can proceed.

5. The method of claim 1, comprising:
recording in the identity ledger an identity claim comprising a personally identifiable information associated with the second party, and the public key of the second party; and
removing the identity claim from the identity ledger after a predetermined amount of time.

6. The method of claim 5, comprising:
recording in the identity ledger an identity verification of the identity claim comprising the identity claim and a public key of a third party verifying the identity claim, wherein the identity verification comprises a positive verification indicating that the third party has verified the personally identifiable information is associated with the second party or a negative verification indicating that the third party has verified that the personally identifiable information is not associated with the second party; and
removing the identity verification from the identity ledger after the predetermined amount of time.

7. The method of claim 1, comprising:
initiating the crypto currency transaction by transferring a first half of the crypto currency to be exchanged in the crypto currency transaction to the second party and recording the transfer in a financial ledger;
verifying the identification associated with the second party; and
finishing the crypto currency transaction by transferring a second half of the crypto currency to be transferred in the crypto currency transaction to the second party and recording the transfer in the financial ledger.

8. The method of claim 1, comprising:
recording in the identity ledger a bundled identity verification of a plurality of identity claims comprising an identity claim in the plurality of identity claims and a public key of a third party verifying the identity claim, wherein an identity verification in the bundled identity verification comprises a positive verification indicating that the third party has verified that the identity claim is associated with the second party or a negative verification indicating that the third party has verified that the identity claim is not associated with the second party.

9. The method of claim 8, extracting from the bundled identity verification the identity verification.

10. A method comprising:
receiving from a first device associated with a first party, an identification associated with a second party, the identification comprising a public key of the second party and an address associated with a private key of the second party;
retrieving an identity ledger comprising an identity creation entry including a ledger address and a ledger public key;
verifying that the ledger address matches the address, and the public key of the second party matches the ledger public key; and
upon verifying the match, sending to the first device a probabilistic confirmation that the identification is associated with the second party.

11. The method of claim 10, wherein the identification associated with the second party comprises a personally identifiable information;
wherein the identity ledger comprises an identity verification entry including a ledger personally identifiable, and verified with a private key of a third party;
wherein said verifying comprises:
decrypting a ledger personally identifiable information with the public key of the third party;
verifying that the ledger personally identifiable information matches the personally identifiable information of the second party;
computing a reliability weight based on the public key of the third party; and
sending to the first device the probabilistic confirmation that the identification is associated with the second party.

12. The method of claim 11, wherein the identity ledger comprises a plurality of identity verification entries verified by a plurality of private keys associated with third parties, wherein each identity verification entry in the plurality of identity verification entries comprises a positive verification and a negative verification;
said computing the reliability weight comprising:
retrieving a plurality of reliability weights associated with the plurality of third parties;
computing a resulting reliability by increasing the resulting reliability by a reliability weight of a positively verifying third party, and decreasing the resulting reliability by a reliability weight of a negatively verifying third party; and
sending to the first device the probabilistic confirmation that the identification is associated with the second party.

13. The method of claim 10, comprising:
recording in the identity ledger an identity claim comprising a personally identifiable information associated with the second party, and the public key of the second party; and
removing the identity claim from the identity ledger after a predetermined amount of time.

14. The method of claim 13, comprising:
recording in the identity ledger an identity verification of the identity claim comprising the identity claim and a public key of a third party verifying the identity claim, wherein the identity verification comprises a positive verification indicating that the third party has verified the personally identifiable information is associated with the second party or a negative verification indicating that the third party has verified that the personally identifiable information is not associated with the second party; and
removing the identity claim from the identity ledger after the predetermined amount of time.

15. A system to reduce computational cost of verifying a crypto currency transaction comprising:
a public node configured to maintain a financial ledger of the crypto currency transaction, and to allow public access to the financial ledger;
a private node configured to maintain an identity ledger of the crypto currency transaction, and to allow only authorized nodes to access the identity ledger, the private node further configured to:
receive from a first device associated with a first party in the crypto currency transaction, an identification associated with a second party in the crypto currency transaction, the identification comprising a public key of the second party and a wallet address associated with a private key of the second party;
retrieve the identity ledger comprising an identity creation entry including a ledger wallet address and a ledger public key;
verify that the ledger wallet address matches the wallet address, and the public key of the second party matches the ledger public key; and
upon verifying the match, send to the first device a confirmation that the crypto currency transaction can proceed.

16. The system of claim 15, wherein the identification associated with the second party comprises a personally identifiable information;
wherein the identity ledger comprises an identity verification entry including a ledger personally identifiable information, and verified with a private key of a third party; and
wherein the private node configured to verify comprises the private node configured to:
decrypt the ledger personally identifiable information with the public key of the third party;
verify that the ledger personally identifiable information matches the personally identifiable information of the second party;
compute a reliability weight associated with the public key of the third party; and
upon verifying the match, send to the first device the reliability weight as a probabilistic confirmation that the crypto currency transaction can proceed.

17. The system of claim 16, wherein the identity ledger comprises a plurality of identity verification entries verified by a plurality of private keys associated with third parties, wherein each identity verification entry in the plurality of identity verification entries comprises a positive verification and a negative verification;
the private node configured to compute the reliability weight comprising the private node configured to:
retrieve a plurality of reliability weights associated with the plurality of third parties;
compute a resulting reliability by increasing the resulting reliability by a reliability weight of a positively verifying third party, and decreasing the resulting reliability by a reliability weight of a negatively verifying third party; and
send to the first device the resulting reliability as the probabilistic confirmation that the crypto currency transaction can proceed.

18. The system of claim 15, the private node configured to:
record in the identity ledger an identity claim comprising a personally identifiable information associated with the second party encrypted with the private key of the second party, and the public key of the second party; and
remove the identity claim from the identity ledger after a predetermined amount of time.

19. The system of claim 18, the private node configured to:
record in the identity ledger an identity verification of the identity claim comprising the identity claim and a public key of a third party verifying the identity claim, wherein the identity verification comprises a positive verification indicating that the third party has verified the personally identifiable information is associated with the second party or a negative verification indicating that the third party has verified that the personally identifiable information is not associated with the second party; and
remove the identity claim from the identity ledger after the predetermined amount of time.

20. The system of claim 15, comprising:
the public node configured to record in the financial ledger a transfer of a first half of the crypto currency to be exchanging the crypto currency transaction to the second party;
the private node configured to verify the identification associated with the second party; and
the public node configured to record in the financial ledger a transfer of a second half of the crypto currency to be exchanging the crypto currency transaction to the second party.
